(19) United States
(12) Patent Application Publication
(10) Pub. No.: US 2010/0029833 A1
(43) Pub. Date: Feb. 4, 2010

(54) RESIN COMPOSITIONS WITH A LOW COEFFICIENT OF THERMAL EXPANSION AND ARTICLES THEREFROM

(75) Inventors: TIMOTHY D. KRIZAN, Willmington, DE (US); Satoru Sekiguchi, Utsunomiya-shi (JP); Hiroyuki Suzuki, Utsunomiya-shi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Willmington, DE (US)

(21) Appl. No.: 12/534,354

(22) Filed: Aug. 3, 2009

Related U.S. Application Data
(63) Continuation of application No. 11/443,230, filed on May 30, 2006, now abandoned.
(60) Provisional application No. 60/685,370, filed on May 27, 2005.

(51) Int. Cl. C08K 3/04

(52) U.S. Cl. 524/496

(57) ABSTRACT

The present disclosure generally relates to resin compositions having a reduced coefficient of thermal expansion achieved by addition of non-spherical, rounded graphite filler. This disclosure further relates to articles made from such resin compositions, also having a reduced coefficient of thermal expansion, and a method for making such articles.

This application claims the benefit of U.S. Application No. 60/685,370, filed May 27, 2005 and U.S. application Ser. No. 11/443,230 filed May 30, 2006.

### FIELD OF THE INVENTION

This invention generally relates to resin compositions having a reduced coefficient of thermal expansion. Specifically, this invention relates to resin compositions wherein the lower coefficient of thermal expansion is achieved by addition and mixing of at least one filler material to the resin composition in question. This invention further relates to articles made from such resin compositions having a reduced coefficient of thermal expansion. This invention also relates to a method for making such articles.

### BACKGROUND OF THE INVENTION

A seal ring is used for sealing lubricant oil fluid in automatic transmission assemblies (AT) where rotating parts in the equipment are involved, for example, in a car engine. Soft aluminum alloys are used for the rotary shaft and the housing thereby making the AT lightweight.

The seal ring is made from a polymeric resin material, metals, etc. For example, cast iron has been widely used for making the seal ring because cast iron shows very good sliding characteristics when the AT is fully lubricated by the ATF (automatic transmission fluid). However, the cast iron seal ring can wear out the rotary shaft and the housing assembly much faster as it has a hardness higher than the lightweight aluminum alloy used for AT. This problem is further aggravated when the AT is running with a reduced level of ATF. Further, cast iron is a stiff material. This can be problematic during installation of the seal ring. Moreover, the efficiency of the seal is compromised when the ATF oil pressure is low.

For facilitating installation or attachment of the seal ring to the AT, a seal ring is subjected to a cut called the gap joint. When the temperature of the AT and the ATF increases, the thermal expansion of the seal ring closes this gap or cut. However, because of the gap joint, it is possible that the seal performance is inconsistent.

Polytetrafluoroethylene (PTFE) is also used as a seal ring material. Because PTFE is soft, it can cause a drag during installation and subsequently, a fracture in the ring. Also, because PTFE resin has a relatively large thermal expansion coefficient, the change in amount of ATF leakage is also large. Further, as the temperature of the AT and ATF increase the seal expands causing compression resulting into a creep modification. Although the seal ring circumference may be lengthened by a corresponding amount to offset the creep modification, the external size of the seal ring becomes larger than the inner diameter size of the housing and the fitting of the ring does not remain tight.

Moreover, when the hardness of the material is low, a solid foreign substance embedded into the seal ring can wear out the mating material.

Polyimide resin has also been used as a seal ring material. Its physical and mechanical properties are especially suitable to form the gap joint. However, the rate of ATF leakage changes with thermal expansion, although the problem may not be as serious as with PTFE. Thus, seal performance suffers. Graphite or other inorganic compounds have been added to reduce the coefficient of thermal expansion, which helps the seal performance. However, defects during gap joint formation and a lowering of flexural strain as a result of the additives can undermine the seal performance.

The present invention addresses these problems. The inventors of the present invention have discovered an optimum composition of the seal ring material such that the flexural strain does not drop below the critical limit required for adequate seal performance and simultaneously, the coefficient of thermal expansion is also lowered such that the seal performance is improved over conventional seal rings over a broad temperature range. Inter alia, the present invention discloses an additive graphite material with a specific surface area range, a specific particle size and its percent by weight in the seal ring material that provides the desired seal performance from the seal rings made by this material.

### SUMMARY OF THE INVENTION

Disclosed herein is a composition comprising: (a) polymer selected from the group consisting of polyimide, polyester imide, polyester amide imide, polyamide imide, polyetherketone, polyetheretherketone, polyetherketoneketone, polyamide, liquid crystalline polyester, polyoxymethylene, polybenzimidazole, fluoropolymer, copolymers of polyimide, copolymers of polyester imide, copolymers of polyester amide imide, copolymers of polyamide imide, copolymers of polyetherketone, copolymers of polyetheretherketone, copolymers of polyetherketoneketone, copolymers of polyamide, copolymers of liquid crystalline polyester, copolymers of polyoxymethylene, copolymers of polybenzimidazole copolymers of fluoropolymer and blends thereof, (b) a non-spherical, rounded, graphite additive material, wherein said graphite additive material has a specific surface area in the range of from about 1.0 m²/g to about 10 m²/g, has an average particle size of less than about 95 microns, and wherein the percent weight of said graphite additive material is in the range of from about 35% to about 70% of the total weight said composition; and

Also disclosed is an article comprising the composition described above.

A further disclosure herein is a process for making said article.

### BRIEF DESCRIPTION OF THE DRAWINGS

The invention will be more fully understood from the following detailed description, taken in connection with the accompanying drawings, in which:

FIG. 1 depicts the evaluation equipment for measuring the relationship between the amount of oil (automatic transmission fluid) leak and the temperature of the seal ring.

FIG. 2 depicts the relationship between coefficient of thermal expansion and the percent weight of graphite additive to polyimide.

FIG. 3 depicts the relationship between the flexural strain of polyimide and percent weight of graphite additive to the polyimide.

FIG. 4 depicts the rate in ml/min of automatic transmission fluid leak as a function of temperature.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

This invention generally relates to resin compositions having a reduced coefficient of thermal expansion. Specifically, this invention relates to resin compositions wherein the lower coefficient of thermal expansion is achieved by addition and mixing of at least one filler material to the resin composition in question. This invention also relates to a process for making such resin compositions. This invention further relates to articles made from such resin compositions having a reduced coefficient of thermal expansion.

### Resin Composition

Generally, the resin composition comprises high-temperature polymeric materials such as engineering polymers. Polymeric materials useful for the present invention include homopolymers and copolymers of polyimide, polyester imide, polyester amide imide, polyamide imide, polyetherketone, polyetheretherketone, polyetherketoneketone, polyamide, liquid crystalline polyester, polyoxymethylene, polybenzimidazole and fluoropolymer and blends thereof. The blends of polymers that are suitable in the present invention are those that are compatible.

Preferred resin compositions are polyimides prepared by the condensation polymerization reaction of aromatic diamines (or derivatives thereof) and aromatic tetraacids (or derivatives thereof). Examples of suitable acid derivatives include pyromellitic dianhydride, biphenyl tetracarboxylic acid dianhydride, benzophenone tetracarboxylic acid dianhydride, etc. Examples of suitable diamines include 4,4′-diamino diphenyl ether, 3,4′-diamino diphenyl ether, p-phenylene diamine, m-phenylene diamine, etc.

A polyimide in the resin composition hereof is polymer in which at least about 80%, preferably at least about 90%, and more preferably essentially all (e.g. at least about 98%) of the linking groups between repeat units are imide groups. An aromatic polyimide as used herein includes an organic polymer in which about 60 to about 100 mol %, preferably about 70 mol % or more, and more preferably about 80 mol % or more of the repeating units of the polymer chain thereof have a structure as represented by the following Formula (I):

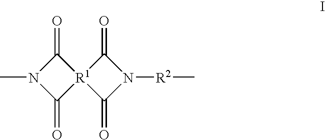

wherein R¹ is a tetravalent aromatic radical and R² is a divalent aromatic radical, as described below.

A polyimide polymer suitable for use herein may be synthesized, for example, by reacting a monomeric aromatic diamine compound (which includes derivatives thereof) with a monomeric aromatic tetracarboxylic acid compound (which includes derivatives thereof), and the tetracarboxylic acid compound can thus be the tetracarboxylic acid itself, the corresponding dianhydride, or a derivative of the tetracarboxylic acid such as a diester diacid or a diester diacidchloride. The reaction of the aromatic diamine compound with an aromatic tetracarboxylic acid compound produces the corresponding polyamic acid, amic ester, amic acid ester, or other reaction product according to the selection of starting materials. An aromatic diamine is typically polymerized with a dianhydride in preference to a tetracarboxylic acid, and in such a reaction a catalyst is frequently used in addition to a solvent. A nitrogen-containing base, phenol or an amphoteric material can be used as such a catalyst.

A polyamic acid, as a precursor to a polyimide, can be obtained by polymerizing an aromatic diamine compound and an aromatic tetracarboxylic acid compound, preferably in substantially equimolar amounts, in an organic polar solvent that is generally a high-boiling solvent such as pyridine, N-methylpyrrolidone, dimethylacetamide, dimethylformamide or mixtures thereof. The amount of all monomers in the solvent can be in the range of about 5 to about 40 wt %, in the range of about 6 to about 35 wt %, or in the range of about 8 to about 30 wt %, based on the combined weight or monomers and solvent. The temperature for the reaction is generally not higher than about 100° C., and may be in the range of about 10° C. to 80° C. The time for the polymerization reaction generally is in the range of about 0.2 to 60 hours.

Imidization to produce the polyimide, i.e. ring closure in the polyamic acid, can then be effected through thermal treatment, chemical dehydration or both, followed by the elimination of a condensate (typically, water or alcohol). For example, ring closure can be effected by a cyclization agent such as pyridine and acetic anhydride, picoline and acetic anhydride, 2,6-lutidine and acetic anhydride, or the like.

In various embodiments of the thus-obtained polyimide, about 60 to 100 mole percent, preferably about 70 mole percent or more, more preferably about 80 mole percent or more, of the repeating units of the polymer chain thereof have a polyimide structure as represented by the following Formula (I):

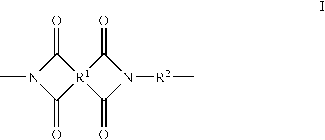

wherein R¹ is a tetravalent aromatic radical derived from the tetracarboxylic acid compound; and R² is a divalent aromatic radical derived from the diamine compound, which may typically be represented as H₂N—R²—NH₂.

A diamine compound as used to prepare a polyimide for a composition hereof may be one or more of the aromatic diamines that can be represented by the structure H₂N—R²—NH₂, wherein R² is a divalent aromatic radical containing up to 16 carbon atoms and, optionally, containing one or more (but typically only one) heteroatoms in the aromatic ring, a heteroatom being, for example, selected from —N—, —O—, or —S—. Also included herein are those R² groups wherein R² is a biphenylene group. Examples of aromatic diamines suitable for use to make a polyimide for a composition hereof include without limitation 2,6-diaminopyridine, 3,5-diaminopyridine, 1,2-diaminobenzene, 1,3-diaminobenzene (also known as m-phenylenediamine or “MPD”), 1,4-diaminobenzene (also known as p-phenylenediamine or “PPD”), 2,6-diaminotoluene, 2,4-diaminotoluene, and benzidines such as benzidine and 3,3′-dimethylbenzidine. The aromatic diamines can be employed singly or in combination. In one embodiment, the aromatic diamine compound is 1,4-diaminobenzene (also known as p-phenylenediamine or “PPD”), 1,3-diaminobenzene (also known as m-phenylenediamine or “MPD”), or mixtures thereof.

Aromatic tetracarboxylic acid compounds suitable for use to prepare a polyimide for a composition hereof may include without limitation aromatic tetracarboxylic acids, acid anhydrides thereof, salts thereof and esters thereof. An aromatic tetracarboxylic acid compound may be as represented by the general Formula (II):

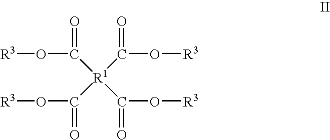

wherein R¹ is a tetravalent aromatic group and each R³ is independently hydrogen or a lower alkyl (e.g. a normal or branched C₁˜C₁₀, C₁˜C₈, C₁˜C₆ or C₁˜C₄) group. In various embodiments, the alkyl group is a C₁ to C₃ alkyl group. In various embodiments, the tetravalent organic group R¹ may have a structure as represented by one of the following formulae:

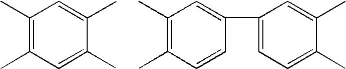

Examples of suitable aromatic tetracarboxylic acids include without limitation 3,3′,4,4′-biphenyltetracarboxylic acid, 2,3,3′,4′-biphenyltetracarboxylic acid, pyromellitic acid, and 3,3′,4,4′-benzophenonetetracarboxylic acid. The aromatic tetracarboxylic acids can be employed singly or in combination. In one embodiment, the aromatic tetracarboxylic acid compound is an aromatic tetracarboxylic dianhydride, particularly 3,3′,4,4′-biphenyltetracarboxylic dianhydride (“BPDA”), pyromellitic dianhydride (“PMDA”), 3,3,4,4′-benzophenonetetracarboxylic dianhydride, or mixtures thereof.

In one embodiment of a composition hereof, a suitable polyimide polymer may be prepared from 3,3′,4,4′-biphenyltetracarboxylic dianhydride (“BPDA”) as the aromatic tetracarboxylic acid compound, and from greater than 60 to about 85 mol % p-phenylenediamine (“PPD”) and 15 to less than 40 mol % m-phenylenediamine (“MPD”) as the aromatic diamine compound. Such a polyimide is described in U.S. Pat. No. 5,886,129 (which is by this reference incorporated as a part hereof for all purposes), and the repeat unit of such a polyimide may also be represented by the structure shown generally in the following Formula (III):

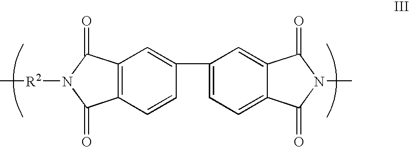

wherein greater than 60 to about 85 mol % of the R² groups are p-phenylene radicals:

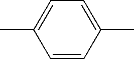

and 15 to less than 40 mol % are m-phenylene radicals:

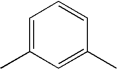

In an alternative embodiment, a suitable polyimide polymer may be prepared from 3,3′,4,4′-biphenyltetracarboxylic dianhydride (“BPDA”) as a dianhydride derivative of the tetracarboxylic acid compound, and 70 mol % p-phenylenediamine and 30 mol % m-phenylenediamine as the diamine compound. Another preferred resin composition is a polyimide (PI) made from pyromellitic acid dianhydride (PMDA) and 4,4′-oxydianiline (ODA).

Polymer and resin compositions have endgroup and crosslinker group concentrations that can be measured by methods known in the art. Endgroups and crosslinker groups can comprise amine groups, carboxylic acid groups, carboxylic anhydride groups, allyl groups, allyl nadic groups, and nadic groups, separately or in combinations. Preferably the concentration of one or more endgroups or crosslinker groups is less than 40 micromoles per gram, or less than any of 30, 20, 10, 5, 2, 1, 0.5, 0.25, 0.1, 0.05, or 0.01 micromoles per gram. Such concentrations can be established by known methods, including preparation of a calibration curve by standard additions and detection by spectroscopy such as infrared, mass, or near infrared, assisted by powdering and extraction of the article by solvents such as methyl ethyl ketone, toluene, or xylene.

One example is BANI-M (a bis-allyl-nadic-imide, CAS Number 91865-54-2, available from Maruzen Petrochemical Company. Japan), which comprises allyl groups at a concentration of about 3.8 millimoles/gram.

Articles prepared from the compositions disclosed herein preferably are made with low extractables, as noted herein. This can be done by minimizing the amount of crosslinkers used, and maximizing the extent of crosslinking without imparting brittleness. Accordingly, the concentration is preferably less than 40 micromoles per gram, or 30, 20, 10, 5, 2, 1, 0.5, 0.25, 0.1, 0.05, or 0.01 micromoles per gram.

The resin compositions of the present invention generally have outstanding mechanical properties, improved thermal and chemical resistance and stability and good sliding characteristics.

### Filler Material

The filler material is mixed with the resin composition during resin formation and/or during processing of the resin composition to prepare the article of use.

The preferred filler material for this invention is graphite. It is preferred for the present invention to use graphite consisting of non-spherical, rounded particles. Commercial suppliers may use the term “spherical graphite” to describe non-flake graphite. As used herein, “non-spherical, rounded” and “non-spherical, rounded graphite” describes the actual geometry of the graphite used in the present invention. The graphite of the present invention is not flake, nor is it actually a perfect sphere. The graphite additive material used herein are particles that may be best described as having a potato-like shape or a globular shape. U.S. Patent No. 2004/0053050 to Guerfi et al., which is incorporated by reference herein, discloses techniques for preparing graphite particles for use in lithium-ion batteries, such graphite being described as “potato-like” in shape. Mathematical methods for describing particle shape are also described. U.S. Pat. No. 5,169,508 to Suzuki et al., which is incorporated by reference herein, contains the term “globular” to describe a graphite particle shape, such graphite being used in electrode applications. JP 05331314 to Tanaka et al. discloses use of spherical graphite in a “Heat-Resistant Resin Sliding Material.” A description used for the graphite particles is “close to perfect sphere” with a smooth surface, very hard, and of uniform size distribution. A reference in the open literature (M. C. Powers, Journal of Sedimentary Petrology, vol. 23, no. 2, (1953) pp. 117-119) describes a qualitative roundness scale for particle characterization. Using that scale, the graphite particles of this invention are of intermediate sphericity, and in the range of “sub-angular” to “rounded” The mid-range is termed “sub-rounded.” Useful types of graphite include “sub-angular”, rounded”, “sub-rounded”, angular, “very angular”, and “well rounded”. Particularly useful types of graphite include “sub-angular”, rounded”, “sub-rounded”, angular, very angular, and well rounded, as characterized in Table 9, page 54 and the accompanying text of “Particle shape: a review and new methods of characterization and classification” by Simon J. Blott and Kenneth Pye in Sedimentology, Volume 55 (2008) Issue 1, Pages 31-63.

A preferred weight of graphite in the composition disclosed herein or an article made therefrom, is in the range of from about 35% to about 70% of the total weight of the article. More preferably, the weight of the graphite in the composition is in the range of from about 55% to about 60% of the total weight. Most preferred is a composition or an article made therefrom, is having a weight of graphite in the range of from about 56.5% to about 58%, or at 57%, based on the total weight of the composition.

A preferred specific surface area of the graphite material is about 10 m²/g or less. Another preferred specific surface area of the graphite material is less than 9, 7, 5, 3, 1, or 0.5 m²/g. A further preferred specific surface area of the graphite material is in the range of from about 1 m²/g to about 10 m²/g. An even further preferred specific surface area of the graphite material is in the range of from about 2 m²/g to about 7 m²/g. A further preferred specific surface area of the graphite material is about 5 m²/g.

When filler is present, a preferred particle size of the filler material graphite is about 100 microns or less, but certainly greater than zero since it is present. Another preferred particle size of the filler material graphite is less than 100, 90, 80, 70, 60, 50, 40, 30, 20, 10, 5, 1, 0.5, or 0.1 microns. A more preferred particle size of the filler material graphite is 75 microns or less, 50 microns or less, or 30 microns or less.

It is also further preferred that said graphite filler material is non-spherical and rounded in shape. The graphite filler material has a sphericity of less than about 1. The bulk density of said graphite is at least 0.20 g/cm³.

### Fibers in the Composition

In addition to the filler material described above, an article prepared from said resin composition material may comprise fibers for reinforcement or other purposes. Fibers suitable for this application are selected from aramid fibers, glass fibers, carbon fibers and mixtures thereof The percent weight of said fibers in such an article is in the range of from 0% to about 10% of the total weight of the article, comprising more than 0.05, 1, 2, 3, 4, 5, 6, 7, 8, or 9% by weight of the total weight of the article.

### Method of Making Articles

Articles with lower coefficient of thermal expansion can be prepared by the combining a non-spherical, rounded graphite filler as disclosed herein with a resin composition as disclosed herein and using a conventional process, such as powder compression, compression molding, extrusion molding, injection molding, reaction injection molding, etc. Optionally, fibers such as aramid, glass and/or carbon may be added during the molding or extrusion step, depending on which is used, or it may be added during resin formation. Sometimes, the resin formation and the step of making the article can be one and the same.

### Uses of Articles

Articles with low coefficient of thermal expansion can be made as described herein, and have utility as shown in the two exemplary embodiments below. Other articles, wherein a low coefficient of thermal expansion is desired, can be made using the composition and method of this invention.

### Seal Ring or Gasket

In one embodiment, an article of use is a seal ring or a gasket. Such a seal ring can be used in equipment in a static environment where there are generally no moving parts. Such a ring can also be used in equipment where moving parts or motion is involved, for example, reciprocating motion or rotary motion. Such rings can also be used for applications wherein a fluid pressure is exerted on such a ring. Pressure exerted when a liquid or a gas evolves during a process can employ such rings. Such rings can also be employed where a seal is required to avoid oil leaks under pressure, such as a transmission fluid leak in an automatic or in pump action.

Further, such rings can also be employed in situations where said ring is compressed from the outside (i.e., the force acts on the outside surface of the ring) in a radial direction toward the center of the seal ring, or in situations where the force acts on the inner surface of the ring, for example, when an equipment chamber is under suction or vacuum (negative pressure). Obviously, such rings can also be employed in situations where both a compression force on the outer surface and a suction force on the inner surface are simultaneously and/or intermittently applied. Applications of such seal rings are described in U.S. Pat. No. 5,988,649, which is herein incorporated by reference in its entirety.

A seal ring can be made by using the process of present invention and the materials of the present invention. A seal ring can be used, for example, in sealing off automatic transmission fluids. This particular operation occurs generally at high temperature and high pressure, coupled with a relative rotary movement between the rotation shaft and the housing over an extended period of time. Therefore, for this use, it is advantageous to have a seal ring material with outstanding sliding characteristics, thermal and chemical resistance and mechanical integrity to withstand the harsh environment of operation. Particularly, the seal ring should provide insulation such that fluid leak is completely stopped, or is negligible or is at least minimal, and constant while the operating temperature of the automatic transmission assembly fluctuates from low to high.

In recent years, metal alloys, such as aluminum alloy, have been used to make the automatic transmission assembly lightweight. The lightweight alloys can generally be physically softer. It is therefore advantageous that the seal ring not damage the soft mating materials to which the seal ring is likely to come in contact. With a higher coefficient of thermal expansion, an increase in temperature will expand the seal ring such that it may damage the lightweight alloy materials used in the automatic transmission assembly. It is an object of the present invention to provide a seal ring with a reduced coefficient of thermal expansion such that the damage to the automatic transmission assembly is minimized. Generally, a seal ring has an indentation or a cut on its circumference so that it attaches snugly to the rotation shaft. This indentation or cut is also known as a joint gap. Various forms of joints can be used, for example, bat joint, scarf joint, step joint, etc., known to a person skilled in the pertinent art. This joint gap on the seal ring is important in preventing oil leaks (automatic transmission fluid leaks) and also for facilitating attachment of the seal ring to the rotation shaft.

In one embodiment, the joint is created by fracturing the seal ring. Fracture is accomplished by providing a physical shock (force) to a polymeric material below its glass transition temperature T_{g}. This is similar to the shock division method used for division processing of large terminal of the connection rod, which connects the piston and crank of an automobile engine. Generally, fracture is usable only when a material does not have a plastic modification region (i.e., below glass transition temperature, in case of a polymeric material such as polyimide) at the fracture processing conditions. Polymers that exhibit a plastic deformation at room temperature can be fractured by exposure to liquid nitrogen or other cryogenic conditions immediately followed by fracture. A method for applying fracture to form a joint in a seal ring is given in U.S. Pat. No. 5,988,649, which is incorporated by reference herein.

When the force exerted on the ring exceeds the maximum limit of the tensile stress of the ring material, a brittle fracture occurs with the crack propagation from the inside surface of the ring to the outside surface of the ring. Depending upon the resin composition of the ring material and the temperature at which the ring is the pressure is exerted on the ring, the ring will have pre-determinable physical characteristics of flexural strain and coefficient of thermal expansion.

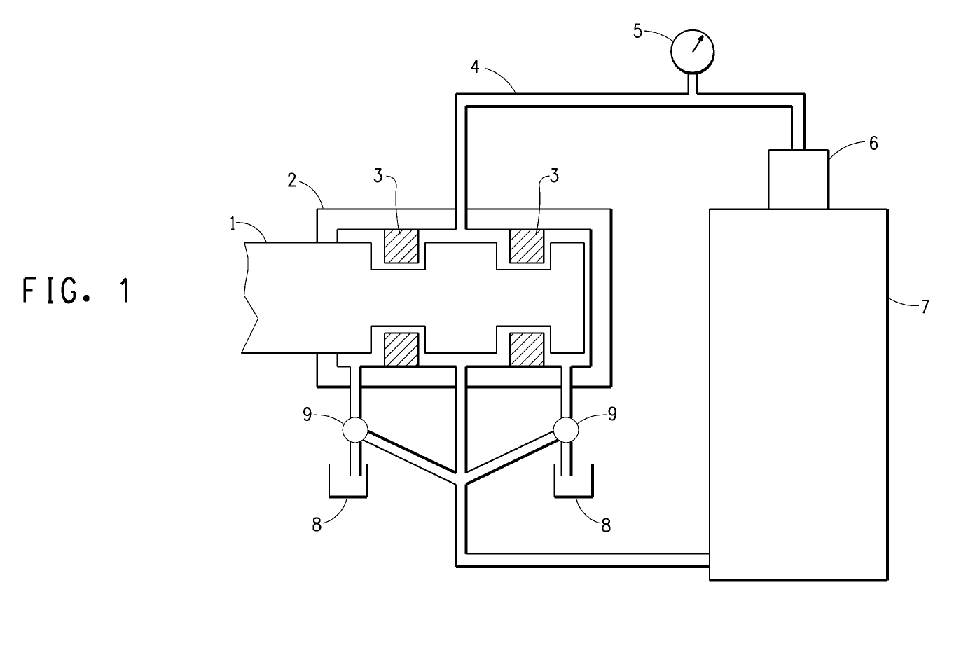

FIG. 1 depicts the evaluation equipment for measuring the relationship between the amount of oil (automatic transmission fluid) leak and the temperature of the seal ring. The shaft 1 is made from aluminum (e.g. aluminum alloy for die-casting). The housing 2 is also made from aluminum (e.g. aluminum alloy for die-casting). The seal ring 3 is shown as part of the housing. The oil supply pipe 4 connects to the housing 2. The supply pipe 4 has an oil pressure gauge 5. The oil pump 6 supplies oil through the supply pipe 4 from the oil tank 7. The measuring cylinder 8 measures the amount of the oil leak through a valve 9.

When the coefficient of thermal expansion of the material of the seal ring differs greatly from that of the automatic transmission assembly (rotation shaft and the housing), a fluctuation in temperature will result in a relatively different expansion and contraction of the seal ring and the automatic transmission assembly. Consequently, the automatic transmission fluid has a higher likelihood of leakage from the gap joint of the seal ring that also expands and contracts. Leakage will affect the performance of the automatic transmission. In order to maintain a minimum, and a relatively constant, leakage of automatic transmission fluid, the inventors of the present invention have found that it is important to maintain the coefficient of thermal expansion in the range of from about 15 micrometer/m-° C. to about 25 micrometer/m-° C. for automatic transmission assembly comprising aluminum alloys. Coefficient of thermal expansion of a material can be lowered by adding fillers such as graphite, carbon fiber, etc. However, addition of such filler materials to reduce the coefficient of thermal expansion, also reduces the flexural strain of the material. A reduction in flexural strain of a material is not a desirable characteristic in this application, i.e., a seal ring.

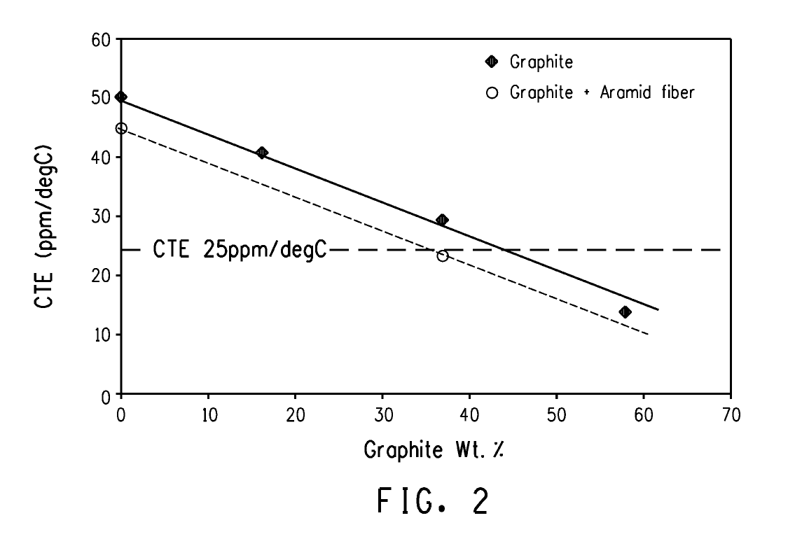

FIG. 2 depicts the relationship between coefficient of thermal expansion and the percent weight of graphite additive to polyimide, a seal ring material. It also shows the same relationship when the said polyimide material was reinforced with aramid fiber. With an increase in weight percent of graphite additive, the coefficient of thermal expansion is lowered. When the aramid fiber was added, the coefficient of thermal expansion was further lowered at all percent weights of the additive graphite. This is a desirable result.

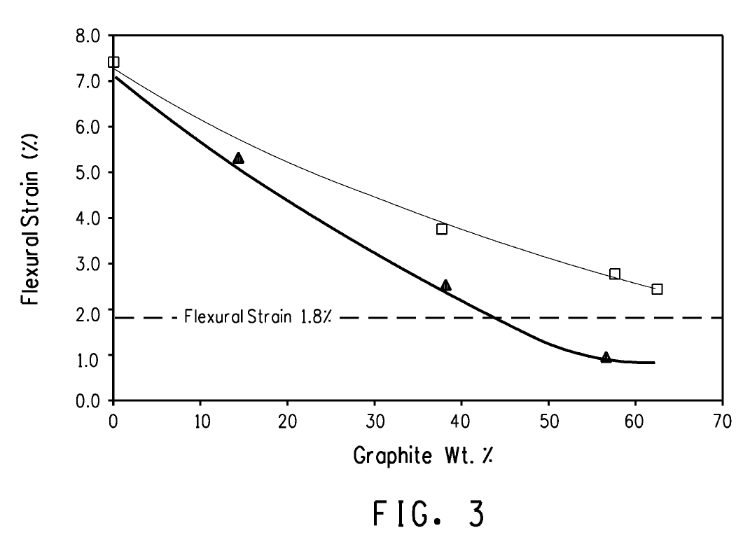

FIG. 3 depicts the relationship between the flexural strain of polyimide, a seal ring material, and percent weight of graphite additive to the polyimide. The relationship is shown for both a conventional graphite additive and the graphite additive of this invention. The graphite additive of this invention is described below. It can be seen from FIG. 3 that the flexural strain decreases with an increase in the graphite additive content in the polyimide material. However, it is also seen that the flexural strain for the polyimide with conventional graphite additive is always lower than that for polyimide with graphite additive of this invention, at all amounts of graphite in the polyimide.

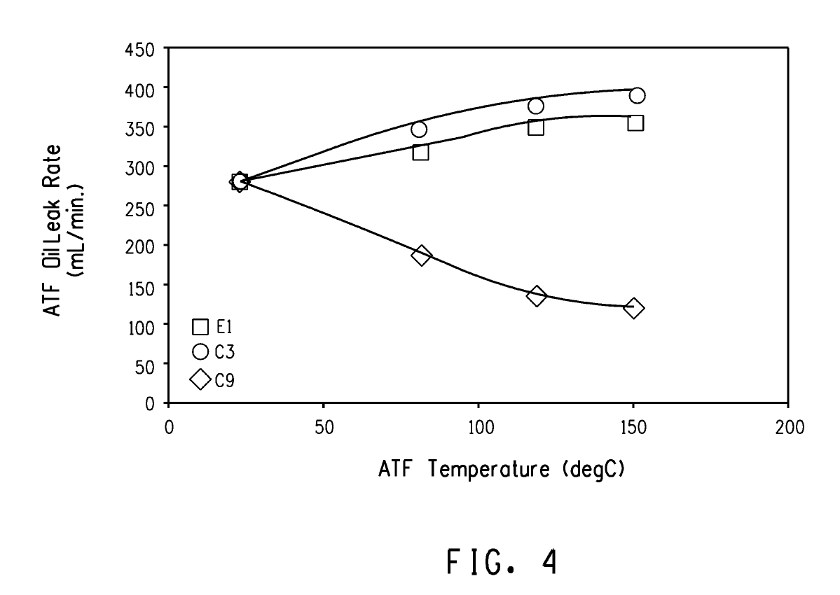

Moreover, the rate in ml/min of automatic transmission fluid leak as a function of temperature is shown in FIG. 4.

The inventors also found that a flexural strain of at least about 1.8% is required in order to carry out a suitable fracture processing when forming the joint for the fractured seal ring. If the flexural strain is less than about 1.8%, during the fracture process for preparing the gap joint, the seal ring is brittle to the extent that material is chipped off at the site where fracture is desired. In addition, the fracture may not take place at the desired location on the seal ring.

Flexural strain of an article made from the resin compositions described herein can be equal to or greater than 1.7, 1.8, 1.9, 2.0, 2.5, 3.0, 3.5, 4.0%, or more. The inventors of the present invention have solved the problem of maintaining the flexural strain to at least about 1.8% while reducing the coefficient of thermal expansion by addition of graphite additive with specific physical properties. Graphite provides excellent lubricating and sliding property characteristics.

A preferred weight percent of graphite of the total weight of the seal ring is in the range of from about 35% to about 70%. Furthermore, a preferred specific surface area of the graphite additive is in the range of from about 1.0 m² /g to about 10 m²/g. A more preferred range is about 5 m²/g to about 10 m²/g or from about 2 m²/g to about 7 m²/g. A most preferred specific surface area is about 5 m²/g.

As described previously, if the percent weight of graphite is reduced to maintain the flexural strain above 1.8%, the coefficient of thermal expansion increases beyond 25 micrometer/m-° C. resulting in undesirable leaks. On the other hand, if the graphite additive is added in the amount such that the coefficient of thermal expansion is within the desired range of from about 15 micrometer/m-° C. to about 25 micrometer/° C., but if the specific surface area of the said graphite additive is more than about 10 m²/g then the flexural strain of the seal ring is lowered to less than about 1.8%, which is undesirable for fracture purposes.

Therefore, the inventors have discovered a range of specific surface area of the graphite additive and the range of the weight percent of the graphite additive that addresses both, the lowering of the coefficient of thermal expansion such that it falls within the range of from about 15-25 micrometer/m-° C. as well as the maintenance of the flexural strain above 1.8%.

Further, it is preferred that the graphite used for the present invention have a non-spherical and rounded shape. A preferred sphericity of said graphite particles is less than 1.

It is also preferred that the average particle size of the graphite additive is less than about 100 microns.

### Experimental

### Examples 1 Through 5 (E1 Through E5)

Examples 1 to 5: PMDA-ODA (pyromellitic acid dianhydride and 4,4′-oxydianiline) polyimide resin particles containing a loading of a non-spherical, rounded graphite additive material (manufactured by Nippon Graphite Industries, as LB-CG graphite) as indicated in Table 1, were prepared and molded into test pieces using a procedure substantially according the procedure described in U.S. Pat. No. 4,360,626, which is incorporated by reference herein.

### Comparative Examples 1 Through 9 (C1 Through C9)

For the comparative examples, resin compositions and various test pieces were made by the same method as described in Example 1. However, different types of graphite additive materials were added. Table 1 shows the different types and amounts of graphite additive materials added to the resin compositions. The graphite additive materials in the comparative examples C1-3, C5, and C6 were manufactured by Nippon Graphite Industries, those of the comparative examples C4, C7, C8, and C9 were manufactured by Asbury Carbons.

The results are shown in Table 1 and selected examples are depicted graphically in FIGS. 2 and 3. Moreover, the rate in ml/min, of automatic transmission fluid leak as a function of temperature is shown in FIG. 4.

### Test Methods

### Coefficient of Thermal Expansion

The coefficient of thermal expansion was measured using The Thermal Analyst 2000 thermal analysis equipment (DuPont Instruments). The coefficient of thermal expansion was measured in the circumferential direction for a seal ring.

The test samples had a width of 3 mm, a height of 3 mm, and a length of 5 mm and the measurement temperature range was from 23° C. through 150° C. The linear coefficient of thermal expansion between the said temperatures was measured.

### Flexural Strength

A three-point bending test was carried out on samples with a width of 3 mm, a height of 3 mm, and a length of 40 mm. The test conditions were as follows: the distance between supports was 20 mm, the radius of a support stand was 3.2 mm (⅛ inch), the radius of a pressurization wedge was 3.2 mm (⅛ inch), and the testing rate was 2 mm/min. Autograph AG-100KG equipment made by Shimadzu Manufacturing was used for measuring the flexural strain. The Flexural Strength (modulus of rupture) at the time of failure was computed from the stress-strain curve.

### Flexural Strain

Maximum flexural strain at the time of fracture was computed from the stress-strain curve.

### Amount of Wear (For the Seal Ring and the Mating Material)

Friction wear testing equipment was used wherein the thrust load and the sliding speed can be adjusted. The test sample of the seal ring had an inner diameter of φ30 mm (a width of 2 mm, a thickness of 4 mm, the joint of 2 mm). The mating material was the aluminum alloy for die-casting, ADC12. A surface pressure of 2 MPa and a speed of 6 m/s were maintained at room temperature.

Automatic transmission fluid was used for lubrication environment. The test was conducted for 7 hours and the amount of wear of the mating material at the end of the test was computed from the difference between the cross sections of the test sample before and after the test. The amount of wear for the seal ring was calculated by measuring the average radial thickness of the ring using a micrometer screw gauge.

### Friction Coefficient

Friction wear testing equipment was used wherein the thrust load and the sliding speed can be adjusted. The test sample of the seal ring had an inner diameter of φ30 mm (a width of 2 mm, a thickness of 4 mm, the joint of 2 mm). The mating material was the aluminum alloy for die-casting, ADC12. A surface pressure of 2 MPa and a speed of 6 m/s were maintained at room temperature.

Automatic transmission fluid was used for lubrication environment.

The test was conducted for 7 hours and the friction coefficient of the flat surface was measured 1 hour before the end of the test.

### Rate of Leakage of the Automatic Transmission Fluid

Seal rings of φ60 mm (a width of 2.3 mm, a thickness of 2.3 mm, joint of 0.5 mm) were attached to an automatic transmission assembly with a shaft made from aluminum (aluminum alloy for die-casting, ADC12) and the housing also made from aluminum (aluminum alloy for die-casting, ADC12), automatic transmission fluid was used as oil under a pressure of 1 MPa, and the rate of leakage (ml/min) at the oil temperature of 23° C. to 150° C. was measured.

Table 1 includes data to demonstrate the present invention, with comparative examples. In the table below the following legend applies:

“NS-R” means non-spherical, rounded graphite

“N” means natural

“S” means synthetic

“SSA” means specific surface area of graphite

“BD” means bulk density of graphite

“APS” means average particle size of graphite

“TE” means tensile elongation

“CTE” means coefficient of thermal expansion

“CF” means coefficient of friction

TABLE 1

| | | EXAMPLES | | | | |
|---|---|---|---|---|---|---|
| | Unit | E1 | E2 | E3 | E4 | E5 |
| Graphite | Wt % | 57 | 57 | 57 | 62 | 57 |
| load | | | | | | |
| Graphite | | NS-R | NS-R | NS-R | NS-R | NS-R |
| Form | | | | | | |
| Graphite | | N | N | N | N | N |
| Source | | | | | | |
| SSA | m²/g | 4.5 | 6.5 | 2.5 | 4.5 | 4.5 |
| BD | g/cm³ | 0.48 | 0.26 | 0.62 | 0.48 | 0.48 |
| APS | ×10^{e-6} m | 20 | 12 | 57 | 20 | 20 |
| Add'l | | None | None | None | None | P-aramid chopped fiber/ |
| fillers/ | | | | | | 5% |
| loading | | | | | | |
| RESULTS | | | | | | |
| TE | % | 2.2 | 2.1 | 2.3 | 1.5 | 2.4 |
| Flexural | % | 3.0 | 2.8 | 2.9 | 2.5 | 3.6 |
| Strain | | | | | | |
| Flexural | MPa | 84 | 71 | 57 | 57 | 88 |
| Strength | | | | | | |
| CTE | ×10^{e-6} m/ | 20 | 22 | 20 | 19 | 15 |
| | ° C. | | | | | |
| CF | | 0.07 | 0.07 | 0.07 | 0.07 | 0.08 |
| Wear of | ×10^{e-6} m/ | 10 | 9 | 11 | 9 | 8 |
| article | 7 hr | Good | Good | Good | Good | Good |
| (seal | | | | | | |
| ring) | | | | | | |
| Wear of | ×10^{e-6} m/ | 3 | 3 | 4 | 3 | 3 |
| mating | 7 hr | Good | Good | Good | Good | Good |
| material | | | | | | |

| | | | | | |
|---|---|---|---|---|---|
| Defect rate of process | Good | Good | Good | Good | Bad |
| for fractured seal ring | | | | | |
| Easiness of | Good | Good | Good | Good | Good |
| assembling seal ring | | | | | |
| shaft | | | | | |

| | | COMPARATIVE EXAMPLES | | | | | | | | |
|---|---|---|---|---|---|---|---|---|---|---|
| | Unit | C1 | C2 | C3 | C4 | C5 | C6 | C7 | C8 | C9 |
| Graphite | Wt % | 57 | 57 | 57 | 57 | 37 | 37 | 37 | 37 | 15 |
| load | | | | | | | | | | |
| Graphite | | flake | flake | flake | flake | spherical | flake | flake | flake | flake |
| Form | | | | | | | | | | |
| Graphite | | N | N | S | N | N | S | S | N | N |
| Source | | | | | | | | | | |
| SSA | m²/g | 12.2 | 7.5 | 155.3 | 20 | 4.5 | 155.3 | 15 | 20 | 20 |
| BD | g/cm³ | 0.09 | 0.08 | 0.10 | 0.16 | 0.48 | 0.10 | 0.14 | 0.16 | 0.16 |
| APS | ×10^{e-6} m | 5 | 5 | 7 | 8 | 20 | 7 | 8 | 8 | 8 |
| Add'l | | None | None | None | None | None | None | None | None | None |
| fillers/ | | | | | | | | | | |
| loading | | | | | | | | | | |
| RESULTS | | | | | | | | | | |
| TE | % | 1.4 | 0.9 | 1.4 | 1.5 | No | No | 3.5 | 2.9 | 6.0 |
| | | | | | | data | data | | | |
| Flexural | % | 1.5 | 1.4 | 1.6 | 1.6 | 3.5 | 1.8 | 2.7 | 2.0 | 4.1 |
| Strain | | | | | | | | | | |
| Flexural | MPa | 84 | 81 | 83 | 85 | 95 | 90 | 90 | 73 | 105 |
| Strength | | | | | | | | | | |
| CTE | ×10^{e-6} m/ | 16 | 22 | 18 | 16 | 33 | 30 | 29 | 29 | 40 |
| | ° C. | | | | | | | | | |
| CF | | 0.07 | 0.07 | 0.09 | 0.09 | 0.07 | 0.08 | 0.09 | 0.08 | 0.07 |
| Wear of | ×10^{e-6} m/ | 18 | 20 | 5 | 15 | 11 | 7 | 30 | 12 | 8 |
| article | 7 hr | Bad | Bad | Good | Good | Good | Good | Bad | Good | Good |
| (seal | | | | | | | | | | |
| ring) | | | | | | | | | | |
| Wear of | ×10^{e-6} m/ | 3 | 3 | 1 | 10 | 3 | 1 | 1 | 5 | 3 |
| mating | 7 hr | Good | Good | Good | Bad | Good | Good | Good | Fair | Good |
| material | | | | | | | | | | |

| | | | | | | | | | |
|---|---|---|---|---|---|---|---|---|---|
| Defect rate of process | Bad | Bad | Bad | Bad | Good | Fair | Good | Good | Good |
| for fractured seal ring | | | | | | | | | |
| Easiness of | Bad | Bad | Bad | Bad | Good | Good | Good | Good | Good |
| assembling seal ring | | | | | | | | | |
| shaft | | | | | | | | | |

What is claimed is:

1. A composition comprising:
(a) polymer selected from the group consisting of polyimide, polyester imide, polyester amide imide, polyamide imide, polyetherketone, polyetheretherketone, polyetherketoneketone, polyamide, liquid crystalline polyester, polyoxymethylene, polybenzimidazole, fluoropolymer, copolymers of polyimide, copolymers of polyester imide, copolymers of polyester amide imide, copolymers of polyamide imide, copolymers of polyetherketone, copolymers of polyetheretherketone, copolymers of polyetherketoneketone, copolymers of polyamide, copolymers of liquid crystalline polyester, copolymers of polyoxymethylene, copolymers of polybenzimidazole, copolymers of fluoropolymer and blends thereof;
(b) a non-spherical, rounded, graphite additive material, wherein said graphite additive material has a specific surface area in the range of from about 1.0 m²/g to about 10 m²/g, has an average particle size of less than about 95 microns, and wherein the percent weight of said graphite additive material is in the range of from about 35% to about 70% of the total weight said composition.

2. The composition as recited in claim 1 wherein said polymer is a polyimide.

3. The composition as recited in claim 2 wherein said polyimide is prepared by a condensation polymerization reaction of an aromatic tetracarboxylic dianhydride or derivative thereof, and a diamine or derivative thereof,
wherein said aromatic tetracarboxylic dianhydride is selected from the group consisting of pyromellitic dianhydride, biphenyl tetracarboxylic acid dianhydride, benzophenone tetracarboxylic acid dianhydride, and combinations thereof, and
wherein said diamine is selected from the group consisting of 4,4′-diamino diphenyl ether, 3,4′-diamino diphenyl ether, p-phenylene diamine, m-phenylene diamine, and combinations thereof; or
wherein said polyimide is made from pyromellitic acid dianhydride (PMDA) and 4,4′-oxydianiline (ODA); or
wherein said polyimide is a copolymer of polyimide derived from 3,3′,4,4′-biphenyl tetracarboxylic dianhydride with p-phenylene diamine and/or m-phenylene diamine.

4. The composition as recited in claim 2 wherein said polyimide is prepared by a condensation polymerization reaction of an aromatic tetracarboxylic dianhydride selected from the group consisting of pyromellitic dianhydride, biphenyl tetracarboxylic acid dianhydride, benzophenone tetracarboxylic acid dianhydride, and combinations thereof; and
a diamine or derivative thereof selected from the group consisting of 4,4′-diamino diphenyl ether, 3,4′-diamino diphenyl ether, p-phenylene diamine, m-phenylene diamine, and combinations thereof.

5. The composition as recited in claim 1 or 2, wherein the bulk density of said graphite additive material is at least about 0.20 g/cm3.

6. The composition of claim 1 wherein said non-spherical, rounded, graphite additive material is present in an amount of about 57% of the total weight said composition.

7. The composition as recited in claim 2 wherein said composition further comprises a fiber selected from the group consisting of aramid fiber, glass fiber, carbon fiber, and mixtures thereof, wherein the percent weight of said fiber is in the range of from about 0% to about 10%.

8. The composition of claim 7 wherein said fiber is poly(p-phenylene terephthalamide).

9. An article, said article comprising the composition of claim 1, 2, 4, 6, 7, or 8.

10. The article of claim 9, wherein said article is a seal ring.

11. A process for making the article of claim 9, said process comprising molding wherein molding is achieved using compression molding, powder compression molding, extrusion molding, injection molding or reaction injection molding.
